(19) United States
(12) Patent Application Publication
(10) Pub. No.: US 2015/0085276 A1
(43) Pub. Date: Mar. 26, 2015

(54) METHOD FOR INSPECTING LENGTH-MEASURABLE PRODUCT, AND INSPECTION DEVICE

(71) Applicant: TORAY INDUSTRIES, INC., TOKYO (JP)

(72) Inventors: Makoto Uchino, Otsu-shi (JP); Osamu Kuramata, Otsu-shi (JP); Nao Minaki, Iyo-gun (JP); Toru Yukutake, Otsu-shi (JP)

(73) Assignee: TORAY INDUSTRIES, INC., TOKYO (JP)

(21) Appl. No.: 14/387,064

(22) PCT Filed: Mar. 14, 2013
(86) PCT No.: PCT/JP2013/057193

§ 371 Date: Sep. 22, 2014

(30) Foreign Application Priority Data
Mar. 23, 2012 (JP) 2012-067372

(51) Int. Cl. G01N 21/89; G01B 11/04

(52) U.S. Cl. CPC G01N 21/89; G01B 11/043
USPC 356/73

(57) ABSTRACT

The method for inspecting a length-measurable product includes manufacturing the length-measurable product 1 whose length at least in one direction can be measured, when a defect 4 occurs in the length-measurable product 1, applies a marking 6 to a length-measurable product 1 having the defect 4, and includes the steps of detecting presence of a defect 4 in the length-measurable product, measuring a length of the length-measurable product 1 at least in one direction, and applying a marking to a predetermined marker area 5 in a length direction of the length-measurable product 1 having the defect 4, on the basis of positional information on the defect obtained in the defect detecting step and length measurement information obtained in the length measuring step.

### CROSS REFERENCE TO RELATED APPLICATIONS

This is the U.S. National Phase application of PCT/JP2013/057193, filed Mar. 14, 2013, which claims priority to Japanese Patent Application No. 2012-067372, filed Mar. 23, 2012, the disclosures of each of these applications being incorporated herein by reference in their entireties for all purposes.

### FIELD OF THE INVENTION

The present invention relates to an inspection method and an inspection device for inspecting a length-measurable product, in which the length-measurable product is inspected during the process of manufacturing the length-measurable product; and if a defect is detected, a marking is applied to a product having the defect.

### BACKGROUND OF THE INVENTION

Threads typified by fibers and hollow fiber membranes, and the like (hereinafter, also simply referred to as threads) have been used and actively utilized in various fields and applications from the past in the form of a thread product formed only by the threads, or a final product manufactured using the threads as a main component element. In particular, in many cases, a bundle of threads obtained by bundling plural threads can significantly improve performances as a product in comparison with a case of a single thread. Thus, bundled products formed by the bundle of threads or final products manufactured by using the bundle product as a main component element have been increasingly widely used.

Here, threads attracting attentions as those forming high functional bundle products include carbon fibers exhibiting high strength and reduced weight, optical fibers supporting the information society, and hollow fiber membranes used in various filters. As described above, these threads usually exhibit excellent performances when used as a bundled product rather than when used as a single thread. Thus, their performances should be guaranteed as the entire bundled product having plural threads converged therein, rather than as the single thread. For this reason, extra care should be taken to manufacture and manage these bundle products.

A description will be given more specifically by giving an example of a hollow fiber membrane filter (hereinafter, also referred to as a “module”) used in water treatment such as wastewater reclamation and desalination of sea water. In general, the hollow fiber membrane filter has a resin or metallic container, called a case, accommodating a bundle of hollow fiber membranes. This filter is designed so as to cause raw water to flow into this container and pass from the outside (or the inside) of the hollow fiber membranes to the inside (or the outside) to achieve filtration effect on the raw water, and to cause the filtered water, from which impurities have been removed, to flow out of the case.

Although there are various kinds of factors that determine the filtration performance of this module, the following two factors are particularly important: the amount of hollow fiber membrane bundle, and the existence or absence of any defective hollow fiber membrane contained in the bundle.

In general, as for the amount of hollow fiber membrane bundle, at least one physical quantity is selected from the following plural physical quantities according to performance required by customers or applications of the module, which is the final product. In other words, the physical quantities include, for example, the total number, the total outside diameter value, the representative outside diameter value, the total surface area, the representative surface area, the total weight, and the representative weight of all the hollow fiber membranes contained in the module (hereinafter, part or all of these are also referred to as “managed quantities”). If these managed quantities fall below a predetermined value, the module cannot fully exert its filtration performance.

On the other hand, the defective hollow fiber membrane includes one having, for example, a scratch, a defect, a foreign substance, a dent, a swelling, or a large hole formed on the surface thereof, and one having, for example, an excessively thick shape (thin membrane), an excessively thin shape (thick membrane), a crushed/flattened shape, a twisted shape, or a clogged shape (hereinafter, part or all of these are also collectively referred to as “defect”). If the hollow fiber membrane bundle, constituting the module, contains such a defective hollow fiber membrane, the module does not fully exert its performance. Furthermore, only the small number of defective hollow fiber membranes contained may lead to a reduction in the product lifetime of the entire module (for example, if the defective portion breaks, the raw water enters the filtered water).

Here, the hollow fiber membrane bundle is generally manufactured by forming a raw material so as to have a hollow shape through an outlet port, applying various processes, winding it using a rotating reel, and cutting all the wound threads at a predetermined position. Furthermore, in order to reduce manufacturing costs, plural hollow fiber membranes are usually formed in a single line at the same time, and wound up with the same single rotating reel. Thus, efficiency of the manufacturing processes improves with increase in the number of threads that can be manufactured in a single line.

However, in reality, the defects as described above possibly occur during the processes of manufacturing the hollow fiber membrane bundle.

For these reasons, with the conventional method of manufacturing a hollow fiber membrane bundle, a worker visually inspects or examines by touch the surfaces on the entire perimeters of all hollow fiber membranes contained in the hollow fiber membrane bundle wound with a predetermined number of rotations, removes a hollow fiber membrane having a defect found therein, and makes up for the deficit in the bundle caused by the removal with a replacement hollow fiber membrane.

With the process of manufacturing the hollow fiber membrane bundle as described above, a bottleneck obviously occurs in the process in which the worker inspects the hollow fiber membranes. Thus, many workers need to be employed to efficiently manufacture the hollow fiber membrane bundle, which leads to a significant increase in manufacturing costs. Furthermore, it is difficult for workers to completely inspect all the hollow fiber membranes (usually including approximately several hundreds) contained in one hollow fiber membrane bundle. Thus, there is a possibility that defects are overlooked, and a hollow fiber membrane containing the defects are included in the final product.

Configurations in Patent Documents 1 and 2 are proposed as means for solving the problems described above. With the method in Patent Document 1, a defect detector detects a defect within optical fiber subjected to drawing, and then, a marking device applies a marking in the vicinity of the defect. However, with this method in Patent Document 1, the marking is applied to a position of the defect in the product, and a worker has to search for the marking when removing it. Thus, only a few changes in the amount of work are made from the conventional process in which inspection is performed and the hollow fiber having the defect is removed, and it is not possible to reduce the number of inspectors.

Furthermore, with the method in Patent Document 2, as in Patent Document 1, optical fiber containing a defect and having a marking applied thereto at the position of the defect are wound with a winding bobbin 1, and by replacing it with another bobbin 2 at a time when the winding of the defect is complete, the defect in the optical fiber is captured at end portion of the winding with the bobbin 1. With this method in Patent Document 2, removal of the defective portion can be easily performed. However, this method is performed on the assumption that one thread runs in a single line. More specifically, in the case where two or more threads run in a single line, if a detective portion of a certain thread is cut off, the length of this thread differs from that of other threads, and hence, cannot be wound with the same rotating reel.

### PATENT LITERATURE

Patent Document 1: Japanese Patent Application Laid-Open No. 2005-283465

Patent Document 2: Japanese Patent Application Laid-Open No. 2000-281379

### SUMMARY OF THE INVENTION

An object of the present invention is to provide a method for inspecting a length-measurable product, and an inspection device, in order to improve efficiency of operation of removing a length-measurable product having a defect.

The method for inspecting a length-measurable product of the present invention includes any of the following configurations (1) to (7) described below.

(1) A method for inspecting a length-measurable product, which during a process of manufacturing the length-measurable product whose length at least in one direction can be measured, when a defect occurs in the length-measurable product, applies a marking to a length-measurable product having the defect, the method including the steps of:

detecting presence of a defect in the length-measurable product;

measuring a length of the length-measurable product at least in one direction; and

applying a marking to a predetermined position in a length direction of the length-measurable product having the defect, on the basis of positional information on the defect obtained in the defect detecting step and length measurement information obtained in the length measuring step.

(2) The method for inspecting a length-measurable product according to (1) described above, further including the step of

conveying the length-measurable product, wherein

the length-measurable product is a product that is continuously manufactured without interruption at least during conveyance by the conveying step.

(3) The method for inspecting a length-measurable product according to (1) or (2) described above, further including the step of

collecting the length-measurable product, wherein

the collecting step is a step of winding the length-measurable product with a certain cycle, and

a position at which the marking is applied in the marking step to the length-measurable product having the defect is determined on the basis of a rotation cycle or rotation angle of the length-measurable product in consideration of winding thickening thereof in the collecting step.

(4) The method for inspecting the length-measurable product according to (1) or (2) described above, further including the step of

collecting the length-measurable product, wherein

the collecting step is a step of collecting the length-measurable product while turning around the length-measurable product at a certain length, and

a position at which the marking is applied in the marking step to the length-measurable product having the defect is determined on the basis of a cycle of turned-around length in the collecting step.

(5) The method for inspecting a length-measurable product according to (1) or (2) described above, further including the step of

collecting the length-measurable product, wherein

the collecting step is a step of collecting the length-measurable product while cutting the length-measurable product into a certain length, and

a position at which the marking is applied in the marking step to the length-measurable product having the defect is determined on the basis of a cut length in the collecting step.

(6) The method for inspecting a length-measurable product according to any of (1) to (5) described above, wherein

two or more lines of the length-measurable products are manufactured in parallel.

(7) The method for inspecting a length-measurable product according to (6) described above, wherein

in the marking step, the marking is applied with marking heads in a number less than the number of lines of the length-measurable product.

A method of manufacturing a length-measurable product of the present invention includes the step of inspecting the length-measurable product in accordance with the method for inspecting a length-measurable product according to any of (1) to (7) described above.

The inspection device for a length-measurable product of the present invention includes any of the following configurations (9) to (15) described below.

(9) An inspection device for a length-measurable product, which in a manufacturing device for the length-measurable product whose length at least in one direction can be measured, when a defect occurs in the length-measurable product, applies a marking to a length-measurable product having the defect, the inspection device including:

a defect detecting unit that detects presence of a defect in the length-measurable product;

a length measuring unit that measures a length of the length-measurable product at least in one direction, and

a marking unit that applies a marking to a predetermined position in a length direction of the length-measurable product having the defect, on the basis of positional information on the defect obtained from the defect detecting unit and length measurement information obtained from the length measuring unit.

(10) The inspection device for a length-measurable product according to (9) described above, further including

a conveying unit that conveys the length-measurable product, wherein

the length-measurable product is a product that is continuously manufactured without interruption at least during conveyance by the conveying unit.

(11) The inspection device for a length-measurable product according to (9) or (10) described above, further including

a collecting unit that collects the length-measurable product, wherein

the collecting unit is a unit that winds the length-measurable product with a certain cycle, and

a position at which the marking unit applies the marking to the length-measurable product having the defect is determined on the basis of a rotation cycle or rotation angle of the length-measurable product in consideration of winding thickening thereof in the collecting unit.

(12) The inspection device for a length-measurable product according to (9) or (10) described above, further including

a collecting unit that collects the length-measurable product, wherein

the collecting unit is a unit that collects the length-measurable product while turning around the length-measurable product at a certain length, and

a position at which the marking unit applies the marking to the length-measurable product having the defect is determined on the basis of a cycle of turned-around length in the collecting unit.

(13) The inspection device for a length-measurable product according to (9) or (10) described above, further including

a collecting unit that collects the length-measurable product, wherein

the collecting unit is a unit that collects the length-measurable product while cutting the length-measurable product into a certain length, and

a position at which the marking unit applies the marking to the length-measurable product having the defect is determined on the basis of a cut length in the collecting unit.

(14) The inspection device for a length-measurable product according to any of (9) to (13) described above, wherein

two or more lines of the length-measurable products are manufactured in parallel.

(15) The inspection device for a length-measurable product according to (14) described above, wherein

in the marking unit, the number of marking heads is less than the number of lines of the length-measurable products.

A manufacturing device for a length-measurable product according to the present invention includes an inspection device for a length-measurable product according to any of (9) to (15) described above.

According to the method for inspecting a length-measurable product of the present invention, a marking can be reliably applied to a predetermined position of a length-measurable product having a defect (hereinafter, referred to as defective product) within a periodic unit of collection regardless of positions of the defective product where the defect occurs. With this configuration, a worker in charge of removal can judge whether the product is good or bad only by viewing the predetermined position within the periodic unit of collection of the product, without searching the entire length-measurable product, whereby it is possible to easily and efficiently remove the defective product having the marking applied thereto.

By using a device for inspecting a length-measurable device having a defect according to the present invention, it is possible to significantly improve efficiency in operations of removing a product having a defect occurring therein, and further to speed up these operations and reduce the number of workers.

### BRIEF DESCRIPTION OF DRAWINGS

FIG. 1 is a top view illustrating an example of an embodiment of a method for inspecting a length-measurable product according to the present invention.

FIG. 2 is a sectional view illustrating another example of a marking head used in the present invention.

FIG. 3 is a top view illustrating an example of a marking step in another embodiment of the method for inspecting a length-measurable product according to the present invention.

FIG. 4 is a sectional view illustrating an example of yet another marking step.

FIG. 5 is a top view illustrating an example of yet another marking step.

FIG. 6 is a perspective view illustrating an example of yet another marking step.

FIGS. 7(a) and 7(b) are schematic views each illustrating an example of a winding and collecting step performed in the present invention. FIG. 7(a) is a side view, and FIG. 7(b) is a top view.

FIGS. 8(a) to 8(c) are schematic views each illustrating an example of a cutting step following the winding and collecting step performed in the present invention. FIGS. 8(a) to 8(c) are views sequentially illustrating operational processes.

FIGS. 9(a) and 9(b) are schematic views each illustrating an example of a turn-around collecting step performed in the present invention. FIG. 9(a) is a side view, and FIG. 9(b) is a top view.

FIGS. 10(a) and 10(b) are schematic views each illustrating an example of a cutting and collecting step performed in the present invention. FIG. 10(a) is a side view, and FIG. 10(b) is a top view.

### DETAILED DESCRIPTION OF EMBODIMENTS OF THE INVENTION

In this description, the length-measurable product represents a product of which length of at least one direction can be measured, and includes, for example, carbon fiber, optical fiber, a hollow fiber membrane, fiber, steel wire, a medical catheter, a film, nonwoven fabric, a steel sheet, and paper. Furthermore, a defect in the length-measurable product includes, for example, an excessively large or excessively small outside diameter value of the length-measurable product, a scratch, a defect, a foreign substance, a dent, swelling, or a large hole on the surface of the length-measurable product. In particular, for example, in the case of the hollow fiber membrane, the defect includes an excessively thick (thin membrane) shape, an excessively thin (thick membrane) shape, a crushed/flattened shape, a twisted shape, and a clogged shape.

Furthermore, in particular, in the case where the hollow fiber membrane is given as an example of the length-measurable product, a bundle product formed by the hollow fiber membrane includes, for example, an ultrafiltration membrane, a microfiltration membrane, a gas separation membrane, a pervaporation membrane, and a dialysis membrane. However, application of the present invention is not limited to water treatment or the hollow fiber membrane used in artificial kidney as described above, and the present invention is applicable to any bundle product, provided that such a bundle product is formed by a thread product such as fiber for clothing, carbon fiber, optical fiber, steel wire, and a medical catheter, which substantially has a structure in which plural threads (length-measurable products) can be manufactured in parallel at the same time. Furthermore, the present invention is applicable to a web-type product such as a film, nonwoven fabric, a steel sheet, and paper.

Embodiments of the present invention will be described below with reference to the drawings, by giving an example of a method for inspecting a hollow fiber membrane serving as a length-measurable product. Note that the present invention is not limited to this embodiment.

For example, in the case of a thread product such as the hollow fiber membrane as described above, the thread product is wound with a rotating reel, and the wound thread is cut to obtain a bundle of threads, whereby it is possible to periodically collect the thread product. At this time, a marking is applied to a thread product having a defect (hereinafter, also referred to as a defective hollow fiber membrane) at a predetermined lengthwise position of the length-measurable product while considering a position to be cut in the future, whereby markings are applied to the same position in the longitudinal direction for all the defective hollow fiber membranes. Alternatively, in the case where the length-measurable product is a web-type product such as a film and a nonwoven fabric, after formation of a film, the marking is applied to a position corresponding to a corner or a side of a plate with consideration of, for example, a position at which the product is cut into a plate shape. At this time, a color, or a number, or a position of the markings may be changed according to the type of defects or the number of defects occurring in the product or the degree of the defect, and it is preferable to use a symbol or a character to provide identification information concerning, for example, the type of defect, the number of defects, the degree of defect, and the specific position (coordinates) of defect occurrence.

An inspection device for a length-measurable product according to the present invention is an inspection device for a length-measurable product that, when a defect occurs in a length-measurable product of which length of at least one direction can be measured, applies a marking to the length-measurable product having the defect. This inspection device can process one line of or two or more lines of length-measurable products continuously running in parallel in the longitudinal direction. This inspection device includes a defect detecting unit, a length measuring unit, and a marking unit. The inspection device may further include a conveying unit and a collecting unit.

The defect detecting unit detects whether any defect exists in the length-measurable product, and obtains positional information on the defect. The defect detecting unit is configured to include an inspecting head and an inspection controlling mechanism. The inspecting head monitors a single thread of a hollow fiber membrane (length-measurable product). For the inspecting head, it may be possible to use, for example, a unit obtained by combining a general-purpose digital camera or analog camera, a lens for a general-purpose cameras, and lighting, an LED lamp or a shape measurement sensor using a laser light. The inspection controlling mechanism processes information obtained by the inspecting head, and actually inspects whether any defect exists. As for the inspection controlling mechanism, it may be possible to employ a system configured by installing, for example, an image capturing board, a signal processing board, a communication board, signal processing software, and system-controlling software to a general-purpose PC, or a commercially available image inspection system.

The length measuring unit measures the length of at least one direction of the length-measurable product, and obtains length measurement information (coordinates or the amount of collection of the length-measurable product in the longitudinal direction). The length measuring unit includes a length measuring head and a length-measurement calculating mechanism. An example of the length measuring head includes a general-purpose encoder for monitoring a state of collection of the collecting unit or a state of conveyance of the conveying unit, or a conveying roll that can measure the number of rotations. The length-measurement calculating mechanism manages the length measurement information so as to be associated with collection cycles of a collecting step, whereby it is possible to synchronize the absolute position on the length-measurable product with collection cycles. As for the length-measurement calculating mechanism, it may be possible to employ a unit having specifically designed system-controlling software installed in a general-purpose PC or a programmable controller. As another example, it may be possible to employ a configuration in which the length-measurement calculating mechanism directly collects necessary length measurement information from a controlling mechanism of the collecting unit or the conveying unit. Furthermore, since the defect detecting unit, which has been already described, inspects the length-measurable product without interruption, it may be possible to employ a configuration in which the length measurement information is supplied directly to a marker controlling mechanism from inspection information that the defect detecting unit has. The length measurement information may be obtained with any of the methods described above. However, the length measurement information needs to be associated with the periodic unit of collection of the collecting unit without fail.

The marking unit applies the marking to a predetermined lengthwise position of the length-measurable product having a defect on the basis of the positional information on the defect provided by the defect detecting unit and the length measurement information provided by the length measuring unit. The marking unit is configured to include a marking head, and a marker controlling mechanism.

By considering a unit (cycle length or periodic angle) according to which the length-measurable product is to be periodically collected in the future, the marker controlling mechanism determines a timing when the marking head is operated to apply the marking to a predetermined position within a periodic unit of collection, on the basis of the length measurement information and the defect occurrence information and the defect positional information, with reference to a conveying speed of the hollow fiber membrane that is designed in advance and positional relationships between the units. In this description, this predetermined position is also referred to as a marker area. The marking head aims at the marker area of the defective hollow fiber membrane, and applies the marking in accordance with an instruction from the marker controlling mechanism.

The number of marking heads arranged may be set so as to be equal to the number of lines of the length-measurable products. Alternatively, it may be possible to set the number of the marking heads so as to be less than the number of lines of the length-measurable products. However, in the case where the number of the marking heads is set so as to be less than the number of lines of the length-measurable products, the marking unit may need to include a marking-head moving mechanism and a movement controlling mechanism. As for the marker head and the marker controlling mechanism, it may be possible to employ, for example, a commercially available laser marker or inkjet printer, an oil-based ink marker, a label attaching device, a stamp marker, and a branding marker. Furthermore, as for the marking-head moving mechanism and the movement controlling mechanism, it may be possible to employ a commercially available movable stage or stage controller.

The marking device for the length-measurable product according to the present invention may include the conveying unit that conveys the length-measurable product. The length-measurable product is continuously manufactured without interruption at least during the time when the length-measurable product is conveyed with the conveying unit. With this configuration, it is possible to ensure that the length-measurable product collected by the collecting unit is collected while the periodic unit of collection is being maintained. The conveying unit is configured to include a conveying roll (driving), a conveying roll (free), a thread path guide, and a conveying-roll (driving) controlling mechanism. These constitutional elements are used by customizing commercially available units according to length-measurable products or processes.

The inspection device for a length-measurable product according to the present invention may include the collecting unit that collects the length-measurable product. Furthermore, the collecting unit can perform collection while plural length-measurable products (for example, hollow fiber membranes) continuously running are being converged into a bundle product. Examples of the collecting unit include a winding and collecting unit, a turn-around collecting unit, and a cutting and collecting unit.

The winding and collecting unit is a unit that winds, with a certain cycle, the length-measurable product passing through the marking unit. The winding and collecting unit is configured to include a reel and a winding and collection controlling mechanism. In the case where the winding and collecting unit is used, the marking unit determines a position at which the marking is applied to the length-measurable product, on the basis of a rotation cycle or rotation angle of the length-measurable product in consideration of winding thickening thereof.

The turn-around collecting unit is a unit that performs collection while the length-measurable product passing through the marking unit is turned around at a certain length. The turn-around collecting unit is configured to include a turn-around gear, a moving guide, and a turn-around collection controlling mechanism. In the case where the turn-around collecting unit is used, the marking unit determines a position at which the marking is applied to the length-measurable product, on the basis of the cycle of the one-turn length.

The cutting and collecting unit is a unit that perform collection while the length-measurable product passing through the marking unit is cut into a certain length. The cutting and collecting unit is configured to include a collection tray, a clip, a clip rail, a cutter, and a cut and collection controlling mechanism. In the case where the cutting and collecting unit is used, the marking unit determines, on the basis of the length of each cut, a position at which the marking is applied to the length-measurable product.

It is only necessary for these collecting units to be used by customizing commercially available collecting device according to the length-measurable product or processes (specifications and requirements).

With a device for manufacturing the length-measurable product including the inspection device for a length-measurable product described above, it is possible to significantly improve efficiency of operation of removing a product having a defect occurring therein, and speed up this removal operation or reduce the number of workers, whereby it is possible to improve efficiency of manufacturing the length-measurable product.

A method for inspecting a length-measurable product according to the present invention is a method for inspecting a length-measurable product in which, during a process of manufacturing a length-measurable product of which length of at least one direction can be measured, the marking is applied to the length-measurable product having a defect when the defect occurs in the length-measurable product. This inspection method includes a defect detecting step, a length measuring step, and a marking step. Furthermore, this inspection method may include a conveying step and/or a collecting step.

In the defect detecting step, one line of or two or more lines of length-measurable products continuously running in parallel in the longitudinal direction are inspected as to whether any defect exists, whereby the positional information on the defect is obtained.

In the length measuring step, the length of at least one direction of the length-measurable product is measured, thereby obtaining the length measurement information.

In the marking step, the marking is applied to a predetermined lengthwise position (marker area) of the length-measurable product having a defect on the basis of the positional information on the defect provided through the defect detecting step and the length measurement information provided through the length measuring step. This method is characterized in that, by considering a unit (cycle length or periodic angle) according to which the length-measurable product is to be periodically collected in the future, the marking is applied to a predetermined position within this periodic unit of collection. The number of the marking heads that apply the marking may be set to be equal to the number of lines of the length-measurable products, or set to be less than the number of lines of the length-measurable products.

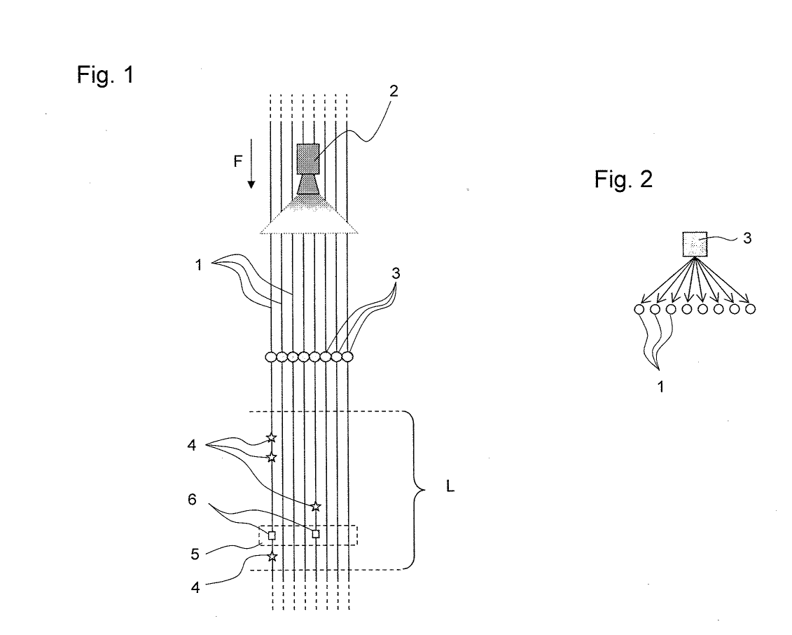

FIG. 1 is a conceptual view illustrating an example of an embodiment of the method for inspecting a length-measurable product.

In FIG. 1, plural length-measurable products 1 continuously run in a direction of an arrow F. An inspecting head 2 is disposed on the upstream side of the plural length-measurable products 1, and marking heads 3 of which number is equal to the number of the length-measurable products 1 are disposed on the downstream side of the plural length-measurable products 1. In this example, star marks are placed at positions of defects 4 on the length-measurable products 1. Furthermore, L represents a periodic unit of collection to be collected in the future in the collecting step disposed on the downstream side and not illustrated.

In the defect detecting step, inspection is performed with the inspecting head 2 and the inspection controlling mechanism, not illustrated, as to whether any defect 4 exists in each of the length-measurable products 1, and in the case where a defect 4 occurs, the positional information on the defect 4 is obtained.

In the length measuring step, the length of the amount of collection (=length) of length-measurable products collected in the collecting step, not illustrated, on the downstream side is measured on an as needed basis, and information thereon is provided to the marking step.

In the marking step, a marking head 3 applies a marking 6 to a predetermined marking area 5 within the periodic unit L of collection of the length-measurable product having the defect, on the basis of the positional information on the defect 4 obtained through the defect detecting step and the length measurement information obtained through the length measuring step. In the case of the present invention, only one mark is necessary to be applied to the marking area 5 even if plural defects occur in the unit L of collection of the same length-measurable product. However, it is preferable to control the shape, the color, the size, or the number of the marks so as to represent characteristics of the defects contained in the unit L of collection.

Note that, although the length measurement information may be obtained directly from the inspection information as described above, in this case, it is necessary for the collection cycle L in the collecting step to be synchronized with the absolute position on the length-measurable product. More specifically, this can be achieved by registering, in advance in the marking unit, the unit L of collection in the collecting step, and performing an initial operation in which a time of starting the inspection is matched with a time of starting the collection in the collecting step.

The example in FIG. 1 is an example of arrangement in which the number of the marking heads 3 is equal to the number of the length-measurable products 1. However, as illustrated in FIGS. 2 to 6, it may be possible to set the number of the marking heads 3 to be less than the number of lines of the length-measurable products 1.

In the embodiment illustrated in FIG. 2, the marking head 3 can apply the marking to a wide area. Thus, the single marking head 3 can apply the marking to plural length-measurable products 1. However, the marking head 3 needs to be one that can control so that the marking is applied only to a length-measurable product to be marked, and the marking is not applied to a length-measurable product 1 that should not be marked. For example, in the case of a general inkjet marker, this can be achieved by using printing patterns that differ according to line numbers of length-measurable products 1 to be marked.

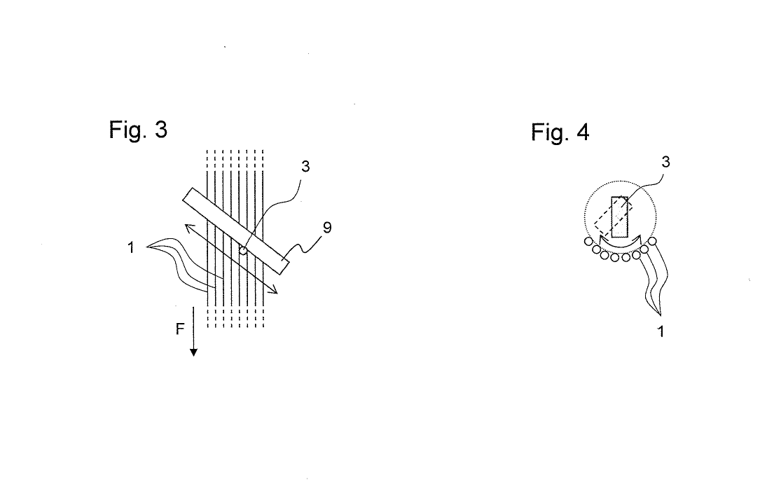

In the embodiment illustrated in FIG. 3, the marking head 3 is configured such that it can move with a marking-head moving mechanism 9 so as to diagonally cross a direction F in which the length-measurable product 1 flows. With this configuration, the marking is applied while the marking head 3 moves, whereby it is possible to apply, in a predetermined marking area, the marking to a length-measurable product having a defect. Note that the example in FIG. 3 is an example in which one marking head 3 is attached to the marking-head moving mechanism 9. However, it may be possible to employ a configuration in which plural marking heads 3 are attached to one marking-head moving mechanism 9, and each of the marking heads 3 applies the marking to plural length-measurable products 1.

In the embodiment illustrated in FIG. 4, in order to reduce the amount of movement of the marking head 3 in the example illustrated in FIG. 3, the length-measurable products 1 are arranged on the circumference of an arc on a plane perpendicular to a direction in which the length-measurable products 1 flow. The marking head 3 applies markings while varying angles of the marking direction with a rotational-type marking-head moving mechanism, which is not illustrated. With this configuration, the markings can be applied, in a predetermined marking area, to a length-measurable product having a defect.

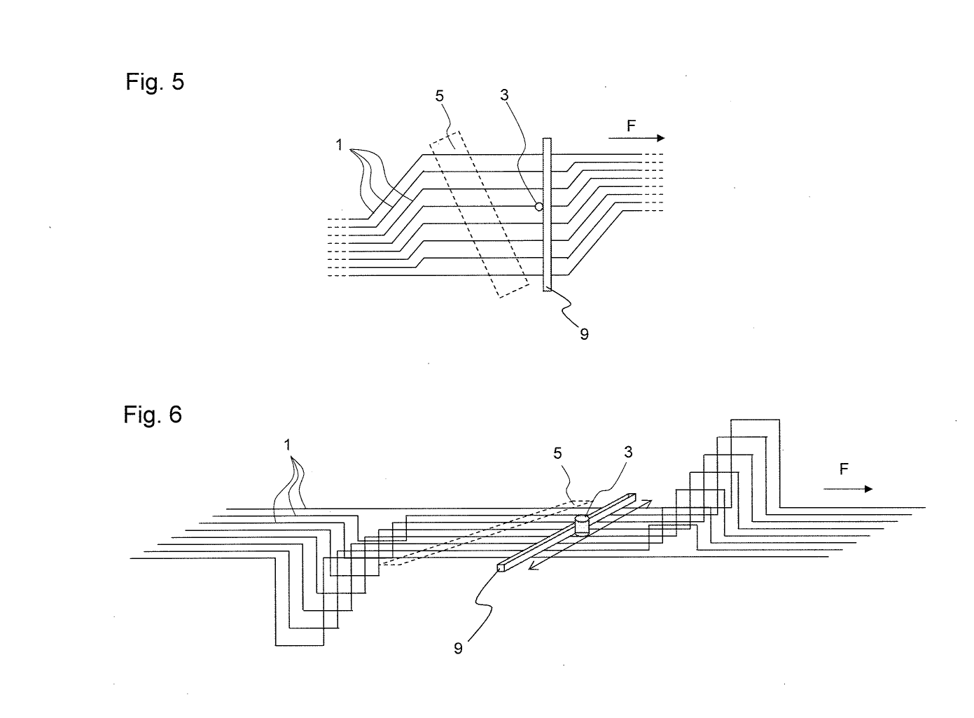

Furthermore, as illustrated in FIGS. 5 and 6, traveling distances in which length-measurable products 1 reach the marking head are varied between adjacent length-measurable products 1, whereby markings can be applied, in a predetermined marking area, to a length-measurable product 1 having a defect.

In FIG. 5, lines of length-measurable products are spread in a plane direction, and a thread-path buffer (mechanism that adjusts a traveling distance of each of the length-measurable products 1) is provided, whereby traveling distances in length-measurable products 1 running on the lower side in the drawing to reach the marking head 3 can be made different from traveling distances of length-measurable products 1 running on the upper side in the drawing. With this configuration, times for reaching the marking head 3 are made different, and during this time lag, the marking head can move, with the marking-head moving mechanism 9, between length-measurable products 1 arranged in parallel. Furthermore, in FIG. 6, lines of length-measurable products are spread in the vertical direction, and a thread-path buffer is provided, whereby traveling distances in which length-measurable products 1 running on the front side in the drawing to reach the marking head 3 can be made different from traveling distances of length-measurable products 1 running on the back side in the drawing. With this configuration, times for reaching the marking head 3 are made different, and during the time lag, the marking head can move, with the marking-head moving mechanism 9, between length-measurable products 1 arranged in parallel.

These configurations in FIGS. 1 to 6 can be used independently or in a combined manner, and design can be freely performed according to convenience of processes of manufacturing the length-measurable products. Furthermore, any method other than those illustrated in FIGS. 1 to 6 may be used in the present invention, provided that such a method substantially have a configuration in which plural marks can be applied in a predetermined marking area to plural length-measurable products manufactured in parallel.

In the conveying step, length-measurable products are conveyed in processes of manufacturing length-measurable products according to the present invention. The length-measurable products can be continuously manufactured without interruption at least during conveyance performed in the conveying step.

In the collecting step, hollow fiber membranes (length-measurable products) are collected while one or more hollow fiber membranes (length-measurable products) continuously running are being united. Examples of the collecting step include a winding and collecting step, a turn-around collecting step, and a cutting and collecting step. As a matter of course, in processes of manufacturing length-measurable products according to the present invention, it is not always necessary to unite plural hollow fiber membranes (length-measurable products) when they are manufactured in parallel, and it may be possible to separately collect the plural hollow fiber membranes (length-measurable products).

The winding and collecting step is a step in which the length-measurable products passing through the marking step are wound with a certain cycle. In the case where the winding and collecting step is performed, a position of the marking applied to the length-measurable product is determined in the marking step on the basis of a rotation cycle or rotation angle of the length-measurable product in consideration of winding thickening thereof. As for the winding thickening, it may be possible to prepare a predicted value thereof on the basis of the number of rotations of the reel, or to obtain the predicted value on the basis of information from a winding controlling mechanism that adjusts a rotational speed of the reel in association with the winding thickening, or to obtain the predicted value through calculation as needed since one cycle of reel rotation changes with the length measuring head provided to the reel.

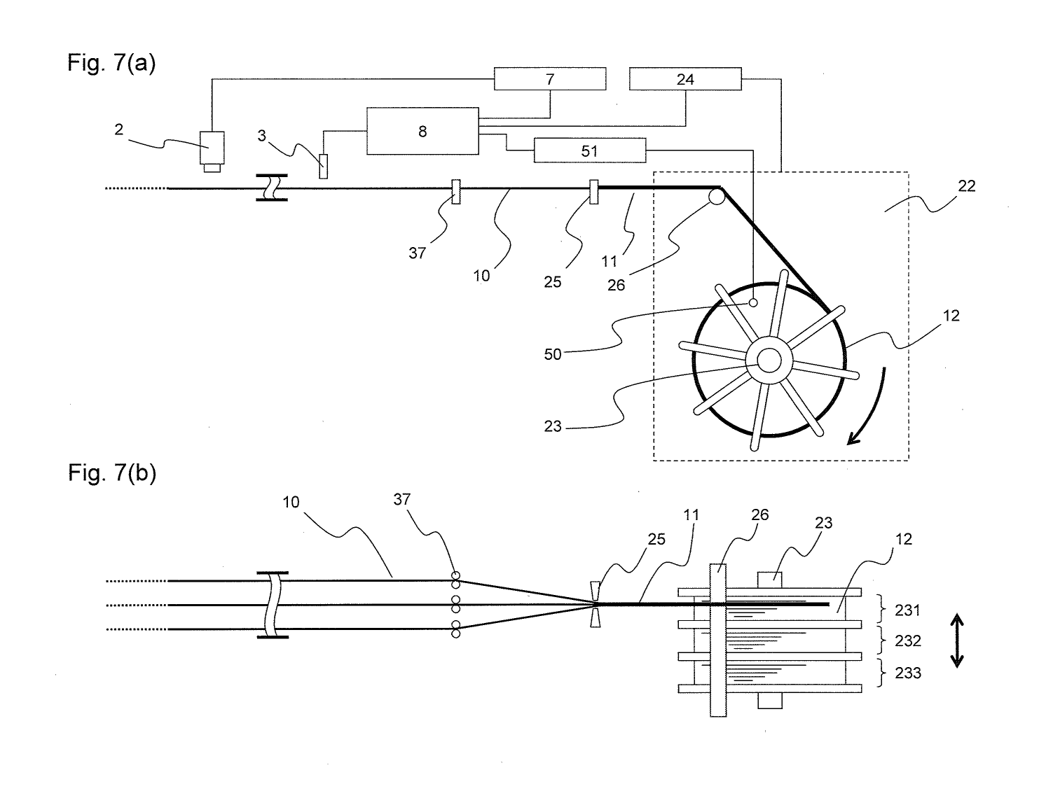

FIGS. 7(a) and 7(b) are conceptual views each illustrating an example of an embodiment of a method of applying a marking to a length-measurable product using the winding and collecting step. FIG. 7(a) is a side view, and FIG. 7(b) is a top view. The inspecting head 2, the marking head 3, an inspection controlling mechanism 7, a marker controlling mechanism 8, a winding and collection controlling mechanism 24, a length measuring head 50, and a length-measurement calculating mechanism 51 are illustrated only in FIG. 7(a).

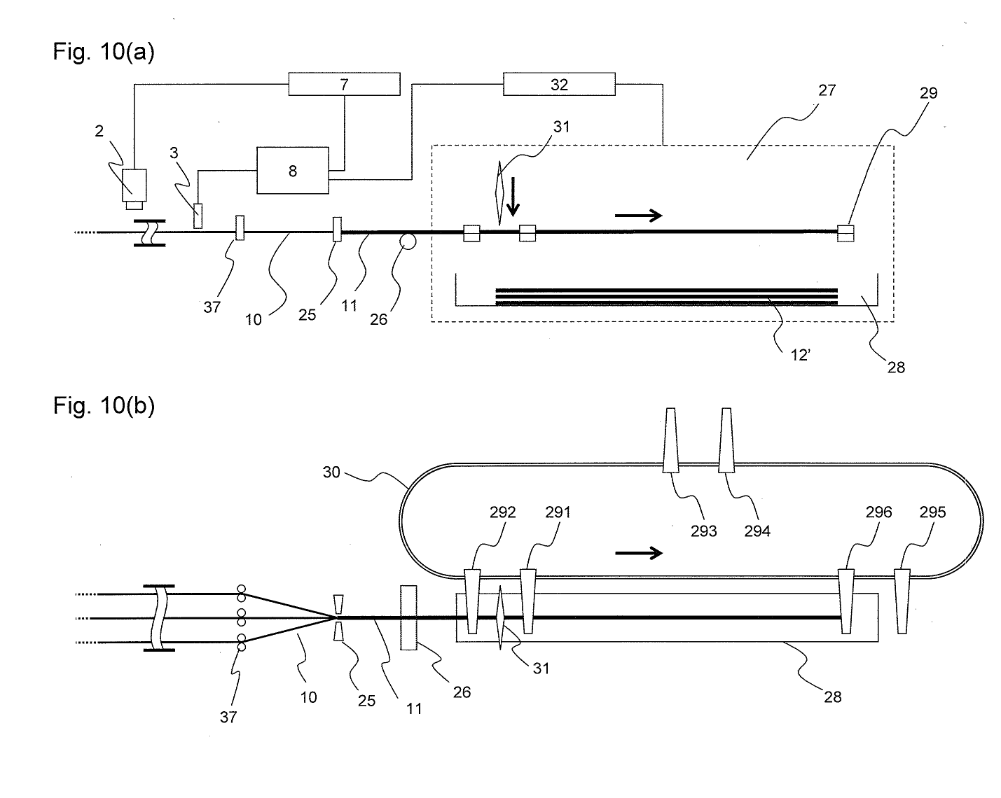

In FIGS. 7(a) and 7(b), 10 represents a single thread of a hollow fiber membrane; 11 represents a united-thread hollow fiber membrane formed by uniting plural single threads; 12 represents a collected united-thread hollow fiber membrane bundle; 22 represents a winding and collecting device; 23 represents a reel; 231, 232, and 233 represent a first reel position, a second reel position, and a third reel position, respectively; 25 represents a united-thread guide; 26 represents a roll; and 37 represents a thread path guide.

The defect detecting unit at least includes the inspecting head 2 and the inspection controlling mechanism 7. The length measuring unit at least includes the length measuring head 50 and the length-measurement calculating mechanism 51. The marking unit at least includes the marking head 3 and the marker controlling mechanism 8.

The conveying unit at least includes a conveying roll (driving), a conveying roll (free), a conveying-roll (driving) controlling mechanism, which are not illustrated, and the thread path guide 37. The collecting unit at least includes the winding and collecting device 22, the reel 23, the united-thread guide 25, and the roll 26.

As illustrated in FIGS. 7(a) and 7(b), the thread path guide 37 sets running positions for the plural single threads 10 of the hollow fiber membranes conveyed from the upper processes, and the single threads are united into the united-thread hollow fiber membrane 11 with the united-thread guide 25. The united-thread hollow fiber membrane 11 is wound with the reel 23 of the winding and collecting device 22 while being pressed against the roll 26, and is formed into the united-thread hollow fiber membrane bundle 12 (note that, in the descriptions of the present invention, an example is given in which three single threads 10 of the hollow fiber membranes are united. However, the number of single threads 10 of the hollow fiber membranes to be united is not limited to three). The length per turn wound by this reel 23 corresponds to the periodic unit L of collection. This periodic unit L of collection can be determined with consideration of the winding thickening occurring in association with the united-thread hollow fiber membrane 11 being wound with the reel 23.

Here, the reel 23 may have plural winding positions such as the first reel position 231, the second reel position 232, and the third reel position 233 as illustrated in FIG. 7(b), and can wind the united-thread hollow fiber membrane 11 at these positions sequentially or at the same time (as described above, this can be applied not only to the united-thread hollow fiber membrane 11 but also to the single thread 10 of the hollow fiber membrane). Furthermore, the reel 23 is configured so as to be able to move in the direction same as the rotational axis. With this movement, the united-thread hollow fiber membrane 11 can be wound uniformly in the width direction within the first reel position 231 (second reel position 232, third reel position 233), or after the completion of winding, the reel position is moved to the next position to continue to wind. Note that, in this embodiment, an example is given in which the number of reel positions is three. However, the number of reel positions is not limited to three. Furthermore, an example is given in which the reel 23 is moved in the direction same as the rotational axis. However, a similar effect can be obtained in the case where the reel 23 is fixed in the direction same as the rotational axis and the united-thread guide 25 is moved in the direction same as the rotational axis of the reel. After the reel 23 finishes winding the predetermined amount of the united-thread hollow fiber membrane bundle 12, the united-thread hollow fiber membrane bundle 12 is cut at a portion joined with the united-thread hollow fiber membrane 11, and the united-thread hollow fiber membrane bundle 12 together with the reel 23 is conveyed to the next cutting step. Note that, after this, in the case where the united-thread hollow fiber membrane 11 is continuously conveyed from the upstream side, a new empty reel 23 is set at once, and winding is started, thereby continuing manufacturing.

The existence or absence of a defect in the hollow fiber membrane is monitored, for example, using a general-purpose digital-camera-type image inspection system, which is used as the inspecting head 2 and the inspection controlling mechanism 7 as illustrated in FIG. 7(a). The digital camera serving as the inspecting head 2 captures images of plural single threads 10 of the hollow fiber membranes conveyed in parallel, and sends the captured images to the inspection controlling mechanism 7. Then, it is determined whether the defect exists in each of the single threads 10 of the hollow fiber membranes, and positional information on the defect is created.

Next, in the length measuring unit, the length measuring head 50 periodically detects a reference position of the reel every time the reel rotates one turn, and performs transmission to the length-measurement calculating mechanism 51 every time. The length-measurement calculating mechanism 51 captures this periodic signal, recognizes the temporal interval of the periodic signal as the unit L of collection, and provides it to the marking step as the length measurement information. At this time, it is preferable to employ a commercially available encoder as the length measuring head 50.

In the marking step, the marking head 3 is controlled with the marker controlling mechanism 8 configured so as to be able to communicate with the inspection controlling mechanism 7 and the length-measurement calculating mechanism 51. Then, the marking head 3 applies the marking to a single thread 10 of a hollow fiber membrane determined by the inspection controlling mechanism 7 to be defective, in the marking area for each periodic unit L of collection on the basis of the length measurement information obtained from the length-measurement calculating mechanism 51.

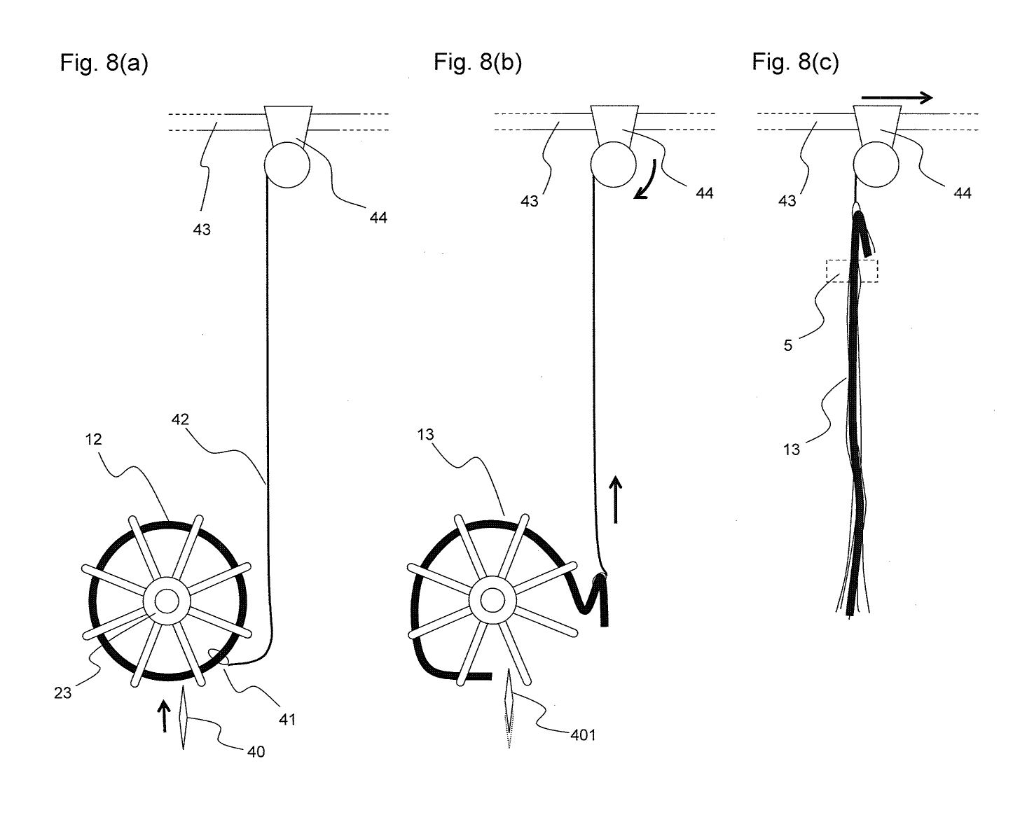

Next, the cutting step following the winding and collecting step illustrated in FIGS. 7(a) and 7(b) will be described with reference to FIG. 8. Here, for ease of understanding, a description will be made of a case where the number of the reel position is one. However, in the case where there are plural reel positions, it is only necessary to increase the following processes according to the number of the reel positions. As illustrated in FIG. 8(a), the reel 23 is first fixed with respect to a cutter 40. Then, a position in the vicinity of the cutter 40 (corresponding to the upstream side in the collecting step) is bound to a hanging rope 42 using a binding unit 41. The hanging rope 42 is configured so as to be wound up by a crane 44 provided with a crane rail 43. After this, as illustrated in FIG. 8(b), by moving the cutter 40 to a position 401, the united-thread hollow fiber membrane bundle 12 is collectively cut, and a hollow fiber membrane bundle 13 is obtained. The hollow fiber membrane bundle 13 has an end portion bound with the hanging rope 42 using the binding unit 41, and hence, is gradually removed from the reel 23 with the crane 44 being operated so as to be rolled up. Finally, as illustrated in FIG. 8(c), the hollow fiber membrane bundle 13 is fully removed from the reel 23, and the crane 44 is moved along the crane rail 43, whereby the hollow fiber membrane bundle 13 is conveyed to the next removing step.

The removing step is a step in which a thread determined in the inspecting step to have an abnormality is removed from the hollow fiber membrane bundle 13. In this removing step, it is possible to efficiently perform the operation of removing the defective hollow fiber membrane in the removing step, which is mainly performed manually, since the marking has been already applied to the defective hollow fiber membrane.

The turn-around collecting step is a step in which a length-measurable product passing through the marking step is collected while being turned around at a predetermined length. In the case where the turn-around collecting step is performed, in the marking step, a position at which the marking is applied to the length-measurable product is determined on the basis of the cycle of the one-turn length.

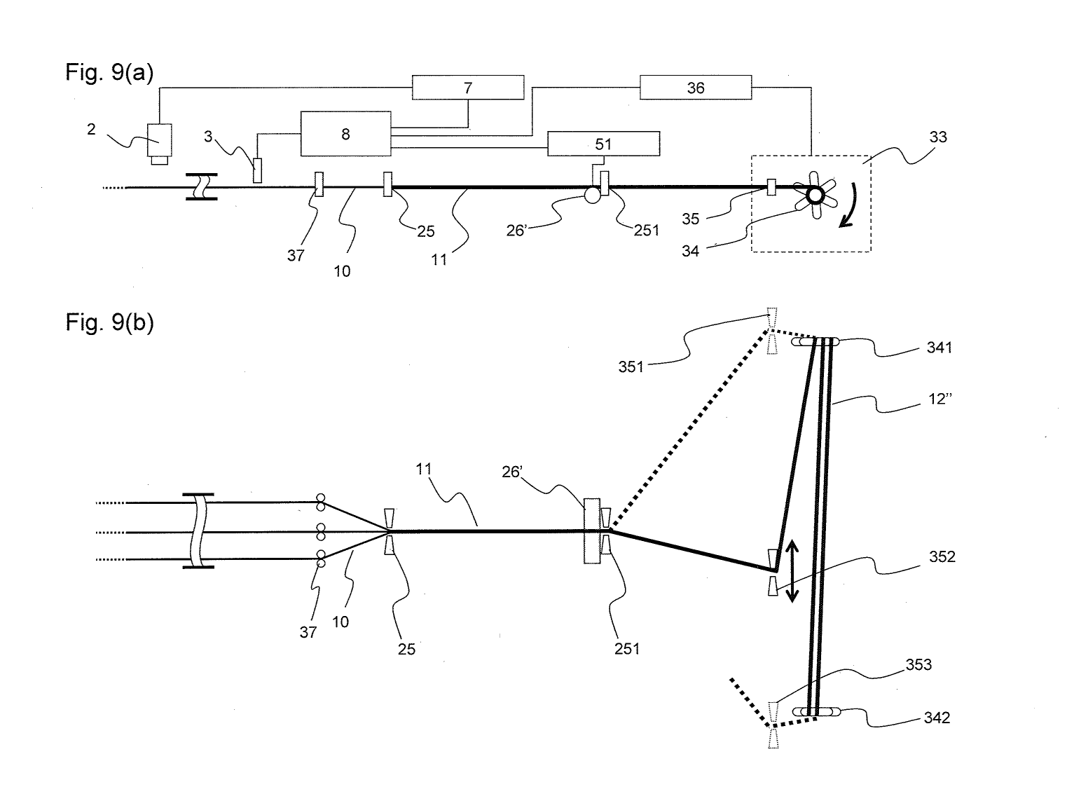

FIGS. 9(a) and 9(b) are conceptual views each illustrating an example of an embodiment of a method of applying the marking to length-measurable products using the turn-around collecting step. FIG. 9(a) is a side view, and FIG. 9(b) is a top view. The inspecting head 2, the marking head 3, the inspection controlling mechanism 7, the marker controlling mechanism 8, a turn-around collection controlling mechanism 36, and the length-measurement calculating mechanism 51 are illustrated only in FIG. 9(a).

In FIGS. 9(a) and 9(b), the united-thread hollow fiber membrane 11 is collected with the turn-around gear 34, which rotates, while being turned around at a predetermined length with the moving guide 35, and a united-thread hollow fiber membrane bundle 12″ is obtained. The predetermined length for the one-turn corresponds to the periodic unit L of collection.

It should be noted that, as described above, this is applicable not only to the united-thread hollow fiber membrane 11 but also to a single thread 10 of a hollow fiber membrane. As illustrated in FIG. 9(b), the turn-around collecting device 33 continuously collects the united-thread hollow fiber membrane 11 as the united-thread hollow fiber membrane bundle 12″ in a manner such that the moving guide 35 swings the united-thread hollow fiber membrane 11 to positions 351, 352, and 353 with a fulcrum-united thread guide 251 being a fulcrum, and the united-thread hollow fiber membrane 11 is looped around predetermined teeth of turn-around gears 341 and 342 that rotate in synchronization with the moving guide 35.

After the predetermined amount of the united-thread hollow fiber membrane bundles 12″ is collected on the turn-around gear 34, the united-thread hollow fiber membrane bundle 12″ is bound at one end portion thereof by a binding unit, not illustrated, and is cut at an end thereof closer to the binding unit and the other end portion with a cutting tool, not illustrated. Then, in this state, the united-thread hollow fiber membrane bundle 12″ is hung with a crane, and is conveyed toward the removing step. Thus, in the case where cutting and collecting is employed as collecting means, a step of cutting the hollow fiber membrane bundle in the cutting step is not necessary.

The existence or absence of any defect in the hollow fiber membrane is monitored with, for example, a general-purpose digital-camera-type image inspection system, which is used as the inspecting head 2 and the inspection controlling mechanism 7 as illustrated in FIG. 9(a). A digital camera serving as the inspecting head 2 captures images of plural single threads 10 of hollow fiber membranes conveyed in parallel. The captured images are sent to the inspection controlling mechanism 7 to determine whether any defect exists in each of the single threads 10 of the hollow fiber membranes, whereby positional information on the defect is created.

Next, in the length measuring unit, a roll 26′ having a length-measuring function rotates in synchronization with conveyance of the length-measurable product 1, and at the same time, always sends length measurement information to the length-measurement calculating mechanism 51 as the number of rotations of this roll 26′ itself having the length-measuring function. The length-measurement calculating mechanism 51 receives this signal concerning the number of rotations, and recognizes, as the unit L of collection, the temporal interval according to which the signal of the number of rotations (or integral multiples of the number of rotations) corresponding to a predetermined unit L of collection is counted in advance, and provides it to the marking step as the length measurement information. At this time, a commercially available encoder may be used as means for counting the number of rotations of the roll 26′ having the length measuring function.

In the marking step, the marking head 3 is controlled by the marker controlling mechanism 8 configured so as to be able to communicate with the inspection controlling mechanism 7 and the length-measurement calculating mechanism 51, and on the basis of the length measurement information obtained from the length-measurement calculating mechanism 51, applies the marking to a single thread 10 of a hollow fiber membrane determined by the inspection controlling mechanism 7 to be defective, in the marking area for each periodic unit L of collection.

According to the present invention, as in the example of the winding and collecting step described above, in the case where the turn-around collecting step is employed as the collecting step, the application of the marking in the marking area 5 of the defective hollow fiber membrane makes it possible to, in the following removing step, improve efficiency of operation of removing the defective hollow fiber membrane in the removing step, which is mainly performed manually.

The cutting and collecting step is a step in which a length-measurable product passing through the marking step is cut into a certain length while being collected. In the case where the cutting and collecting step is performed, in the marking step, the position at which the marking is applied to the length-measurable product is determined on the basis of a unit length of cut corresponding to the unit L of collection.

FIGS. 10(a) and 10(b) are conceptual view each illustrating an example of an embodiment of a method of applying a marking to a length-measurable product using the cutting and collecting step. FIG. 10(a) is a side view, and FIG. 10(b) is a top view. The inspecting head 2, the marking head 3, the inspection controlling mechanism 7, the marker controlling mechanism 8, and a cut and collection controlling mechanism 32 are illustrated only in FIG. 10(a).

In FIGS. 10(a) and 10(b), the united-thread hollow fiber membrane 11 is cut into a predetermined length with a cutter 31, and is collected on a collection tray 28 of a cutting and collecting device 27, thereby obtaining a united-thread hollow fiber membrane bundle 12′. This predetermined length of cutting corresponds to the periodic unit L of collection.

It should be noted that, as described above, this is applicable not only to the united-thread hollow fiber membrane 11 but also to a single thread 10 of a hollow fiber membrane. At the time of cutting, the united-thread hollow fiber membrane 11 is fixed with a clip 29. As illustrated in FIG. 10(b), clips 291 to 296 circulate on a clip rail 30 at the speed same as that of the united-thread hollow fiber membrane 11 with specific intervals being given therebetween, holds the united-thread hollow fiber membrane 11 at a position of the clip 292, and can move while maintaining this state. As a result, as illustrated in FIG. 10(b), the united-thread hollow fiber membrane 11 is cut with the cutter 31 at a time when the united-thread hollow fiber membrane 11 is held with three clips 291, 292, and 296. Immediately after this, the clips 291 and 296 release it, so that the united-thread hollow fiber membrane bundle 11 is collected on the collection tray 28. However, the clip 292 continues to move to the position of the clip 292 while keeping holding the united-thread hollow fiber membrane 11. By repeating these operations, the united-thread hollow fiber membrane bundles 12′ are continuously collected.

After the predetermined amount of the united-thread hollow fiber membrane bundles 12′ is collected on the collection tray 28, the united-thread hollow fiber membrane bundle 12′ is bound at one end portion thereof by a binding unit, not illustrated, is hung with a crane, and is conveyed toward the removing step. Thus, in the case where cutting and collecting are employed as the collecting means, a step of cutting the hollow fiber membrane bundle is not necessary in the cutting step.

The existence or absence of any defect in the hollow fiber membrane is monitored with, for example, a general-purpose digital-camera-type image inspection system, which is used as the inspecting head 2 and the inspection controlling mechanism 7 as illustrated in FIG. 10(a). A digital camera serving as the inspecting head 2 captures images of plural single threads 10 of hollow fiber membranes conveyed in parallel. The captured images are sent to the inspection controlling mechanism 7 to determine whether any defect exists in each of the single threads 10 of the hollow fiber membranes, whereby positional information on the defect is created.

Next, as for the length measuring unit, functions of the defect detecting unit and the collecting unit are used. More specifically, the defect detecting unit inspects the length-measurable product without interruption, and hence, directly supplies the marker controlling mechanism 8 with the length measurement information from this inspection information, and the collecting unit supplies the marker controlling mechanism 8 with a time of starting collecting the length-measurable product, whereby it is possible to identify the marker area in the marking step, and apply the marking.

The marking head 3 is controlled by the marker controlling mechanism 8 configured so as to be able to communicate with the inspection controlling mechanism 7 and the cut and collection controlling mechanism 32, and, in a marking area, applies the marking to a single thread 10 of a hollow fiber membrane determined by the inspection controlling mechanism 7 to be defective for each periodic unit L of collection.

According to the present invention, as in the example of the winding and collecting step and the turn-around collecting step described above, in the case where the cutting and collecting step is employed as the collecting step, the application of the marking in the marking area 5 of the defective hollow fiber membrane makes it possible to, in the following removing step, improve efficiency of operation of removing the defective hollow fiber membrane in the removing step, which is mainly performed manually.

As described above, using the device of manufacturing a length-measurable product described above, the method of manufacturing a length-measurable product according to the present invention can efficiently and stably manufacture high-quality length-measurable products.

### EXAMPLES

### Example 1

With the configurations illustrated in FIGS. 1, 7, and 8, hollow fiber membrane bundles were manufactured. Note that the number of single threads manufactured in parallel at the same time was set to three, and in the case of FIG. 1, the three single threads from the left in the drawing were the targets (the other five single threads do not exist). The conveying unit was configured to control a commercially available driving roll with a motor and an inverter, and connect part thereof using a free roll. For the marking unit, a commercially available inkjet printer was used, the number of ink nozzles serving as the marking head was set so as to correspond to the number of single threads (three ink nozzles in this example), and this inkjet printer was controlled with a commercially available programmable controller having self-made control software using a ladder language installed therein. For the collecting unit, a winding and collecting device controlled with a commercially available programmable controller having self-made control software installed therein was used. A reel having a circumferential length of 1.4 m was used. For the defect detecting unit, a commercially available LED lamp, a digital line sensor camera, a lens for general-purpose cameras, an image capturing board, a signal processing board, a general-purpose PC, and self-made system-controlling software using a C language were used. For the length measuring unit, one turn of the reel was detected using a commercially available encoder, and control was performed using a programmable controller having self-made control software using a ladder language. Note that the general-purpose PC of the defect detecting unit, and the programmable controllers of the length measuring unit, the marking unit, and the collecting unit were configured to be able to communicate with each other.

As for conditions for manufacturing the hollow fiber membranes, a design value of the outside diameter was set to 1425 μm. The hollow fiber membrane bundle collected by the collecting unit was incorporated into a module for water treatment, which is a final product. In order to ensure the performance of this module, a standard value for the total surface area needs to be set to 4.02 m². Here, if the unit L of collection is 1400 mm and the hollow fiber membrane bundle is formed by 642 single threads, the total surface area is 4.0216806 m², which satisfies the standard value. Thus, in the case of the manufacturing conditions with three united threads, the reel was rotated by 214 turns. Furthermore, the marking area was set in the range of 300 mm to 500 mm with a reference (0 mm) being set to a position where the united-thread hollow fiber membrane bundle is cut in the cutting step.

Under the conditions described above, the hollow fiber membrane bundle was manufactured. As a result, depending on the manufacturing states of a certain lot, the defect detecting unit detected 5 defective hollow fiber membranes (scratch), 35 defective hollow fiber membranes (foreign substance), and 2 defective hollow fiber membranes (swelling). Furthermore, in conjunction with the manufacturing device starting its operation, the length measuring unit notified, every time the reel rotates once, the marking unit of the length measurement information that the reference point of the reel passes through a predetermined position; the marking unit obtained information on a defect from the defect detecting unit; and in a marking area, the marking was applied to a single thread of a hollow fiber having a defect with consideration of the unit L of collection. Note that operation was performed under a condition that only one marking was applied even in the case where plural defects occurred in the same single thread during the unit L of collection. Thus, finally, 39 markings in total were applied.

For the united-thread hollow fiber membrane bundle, which had been wound with the reel and for which collection was completed, one end portion thereof was bundled by the binding unit in the cutting step to obtain a hollow fiber membrane bundle. Then, the hollow fiber membrane bundle thus obtained was hung with a crane, and was conveyed toward the removing step. In the removing step, a special worker intensively checked positions in the range of 300 mm to 500 mm with the reference (0 mm) being set to a position where the hollow fiber membrane bundle was cut, found the 39 markings, and removed 39 single threads from 642 single threads. Furthermore, accuracy of positions of the markings were also checked. As a result, even though winding thickening occurred at the end of collection, all the 39 markings were located within a predetermined marking area. Then, 39 single threads, in which it had been already confirmed that no defect exists, were added to this hollow fiber membrane bundle.

The hollow fiber membrane manufactured as described above was assembled in a module, and final inspection before the shipment of the module was performed. As a result, the module exhibited sufficient filtration performance.

### Example 2

At a certain time, facility modifications were performed for Example 1 described above in a manner such that the number of single threads to be manufactured in parallel was increased from three to eight to increase efficiencies in manufacturing, and the speed of formation of a membrane and the conveying speed were increased by 20% from the previous one. At the same time, in order to reduce the number of processes, the collecting step is replaced with cutting and collection illustrated in FIG. 10 for the purpose of removing the cutting step.

With these changes, in the marking unit, as illustrated in FIG. 3, three marking nozzles were attached to three single-axis movable stages (one nozzle is illustrated in FIG. 3), each of which can operate independently, and each of the single-axis movable stages was disposed diagonally with respect to a direction F in which the single thread hollow fiber membrane travels. The three respective nozzles were set so as to each apply markings to three membranes, two membranes, and three membranes of the eight single thread hollow fiber membranes. Furthermore, in order to adequately apply markings to marking areas in a manner that can follow the conveying speed that had been increased by 20%, the conveying unit is configured such that, as illustrated in FIG. 6, lines of the single thread hollow fiber membranes were spread in the vertical direction, and thread-path buffers were provided (more precisely, thread-path buffers were designed appropriately for a group of three, a group of two, and a group of three from the edge).

Furthermore, in the length measuring unit, the system that monitored the rotation of the reel using the encoder was replaced with a system in which circulation cycles of clips controlled by the programmable controller (in which self-made software for controlling is installed) employed as the cut and collection controlling mechanism were provided to the marking unit as the length measurement information (note that other configurations were similar to those in Example 1).

As described in Example 1, conditions for manufacturing the hollow fiber membrane were set such that the design value of the outside diameter was 1425 μm, and the standard value for the total surface area of the hollow fiber membrane bundle needs to be 4.02 m² in order to ensure the performance of the module, which is the final product. Thus, it was necessary to configure the hollow fiber membrane bundle with 642 single threads or more and with the unit L of collection of 1400 mm. Additionally, considering that parallel manufacturing was performed with eight threads, collection performed by the collecting unit (cutting and collecting) was set to 81 times.

Under these conditions, the hollow fiber membrane bundle was manufactured. As a result, depending on the manufacturing states of a certain lot, the defect detecting unit detected 2 defective hollow fiber membranes (scratch), 25 defective hollow fiber membranes (foreign substance), 4 defective hollow fiber membranes (defect), and 10 defective hollow fiber membranes (dent). Furthermore, in conjunction with the manufacturing device starting its operation, the collecting unit having a function of the length measuring unit notified, for every cut, the marking unit of what had actually been done as the length measurement information; the marking unit obtained information on a defect from the defect detecting unit, and in a marking area, the marking was applied to a single thread of a hollow fiber containing a defect with consideration of the unit L of collection. Note that operation was performed under a condition that only one marking was applied even in the case where plural defects occurred in the same single thread during the unit L of collection. Thus, finally, 37 markings in total were applied.

For the united-thread hollow fiber membrane bundle, which had been collected on the collection tray and for which collection was completed, one end portion thereof was bundled by the binding unit in the collecting step to obtain a hollow fiber membrane bundle. Then, the hollow fiber membrane bundle thus obtained was hung with a crane, and was conveyed toward the removing step. In the removing step, a special worker intensively checked positions in the range of 300 mm to 500 mm with the reference (0 mm) being set to a position where the hollow fiber membrane bundle is cut, found the 37 markings, and removed 37 single threads from 648 single threads. Furthermore, accuracy of positions of the markings was also checked. As a result, even though operation was performed at the conveying speed that had been increased by 20% from the previous one, and the markings were applied with three inkjet nozzles in parallel manufacturing with eight threads, all the 37 markings were located within a predetermined marking area. Then, 31 single threads, in which it had been already confirmed that no defect exists, were added to this hollow fiber membrane bundle (in order to correctly achieve performance of the module, it is only necessary for the hollow fiber membrane bundle to be formed by 642 single threads).

The hollow fiber membrane manufactured as described above was incorporated in a module, and final inspection before the shipment of the module was performed. As a result, the module exhibited sufficient filtration performance.

### Comparative Example 1

On the other hand, in manufacturing states similar to those in Example 1, a hollow fiber membrane bundle was manufactured without performing the inspection and the marking constituting the present invention, and the effects of the present invention were confirmed. More specifically, in the removing step, a special worker first inspected the entire hollow fiber membrane bundle formed by 642 single threads and conveyed into the removing step, and if any defect was found, removed this hollow fiber membrane from the hollow fiber membrane bundle.

As a result, as compared with the case of Example 1, significantly large areas needed to be inspected in order to find very small defects which are difficult to be viewed, which are not known whether to exist or not, and the type of which is not known. Thus, working time was ten or more times as much as that was in Example 1 to finish inspecting one hollow fiber membrane bundle and removing defective hollow fiber membranes.

Furthermore, large physical and mental burdens were imposed on the worker, and significantly longer break time was necessary to maintain quality of work.

Furthermore, even though the operations were performed while time and physical considerations were given, variations in work quality, which were specific to manual operations, occurred, and the worker overlooked a defective hollow fiber membrane (large hole), which is a serious defect, in a certain lot. A module was manufactured in a state where the defective hollow fiber membrane was contained, and final inspection before the shipment of this module was performed for the module. As a result, this module did not exhibit predetermined filtration performance. This module was decomposed, was subjected to examination to determine the cause, and then, was discarded.

### Comparative Example 2

Further, in the manufacturing states of Example 1, a hollow fiber membrane bundle was manufactured by performing inspection and marking with a conventional configuration different from the inspection and the marking constituting the present invention, and the effects of the present invention were confirmed. More specifically, in the marking step, a marking was applied to a portion detected by the inspection device to have a defect. Then, in the removing step, a special worker first checked the entire hollow fiber membrane bundle formed by 642 single threads and conveyed into the removing step as to whether the marking exists or not, and if any marking was found, removed this hollow fiber membrane from the hollow fiber membrane bundle.

As a result, although the working burden was reduced to some extent since it is only necessary to search for the marking, which is easy to be viewed as compared with the case of Comparative Example 1, it is still necessary to check significantly large areas as compared with the case of Example 1 in order to find the marking, of which existence is not known. Thus, working time was approximately eight times as much as that was in Example 1 to finish inspecting one hollow fiber membrane bundle and removing defective hollow fiber membranes.

It should be noted that, in Comparative Example 2, a similar making was applied to all types of defects. Thus, check for the marking was easier than the inspection in Comparative Example 1, and was highly reliably performed, and fortunately, no defective hollow fiber membrane being overlooked occurred in Comparative Example 2.

However, substantially, like Comparative Example 1, careful attention was required to observe the entire hollow fiber membrane bundle. Thus, Comparative Example 2 does not lead to a reduction in physical and mental burdens imposed on the worker, and break time similar to that in Comparative Example 1 was necessary.

### REFERENCE SIGNS LIST

1 Single thread of hollow fiber membrane (example of length-measurable product)
2 Inspecting head
3 Marking head
4 Defect
5 Marking area
6 Marking
7 Inspection controlling mechanism
8 Marker controlling mechanism
9 Marking-head moving mechanism
10 Single thread of hollow fiber membrane (length-measurable product)
11 United-thread hollow fiber membrane having plural single threads united therein
12 Collected united-thread hollow fiber membrane bundle
12′ United-thread hollow fiber membrane bundle collected after cutting
12″ United-thread hollow fiber membrane bundle collected through turning around
13 Hollow fiber membrane bundle
22 Winding and collecting device
23 Reel
231 First reel position
232 Second reel position
233 Third reel position
24 Winding and collection controlling mechanism
25 United-thread guide
251 Fulcrum-united thread guide
26 Roll
26′ Roll having a length measuring function
27 Cutting and collecting device
28 Collection tray
29 Clip
291, 292, 293, 294, 295, 296 Clip (individual)
30 Clip rail
31 Cutter
32 Cut and collection controlling mechanism
33 Turn-around collecting device
34, 341, 342 Turn-around gear
35 Moving guide
351, 352, 353 Position of moving guide
36 Turn-around collection controlling mechanism
37 Thread path guide
40 Cutter
401 Cutter at a cutting position
41 Binding unit
42 Hanging rope
43 Crane rail
44 Crane
50 Length measuring head
51 Length-measurement calculating mechanism
F Traveling direction of length-measurable product
L Periodic unit of collection

1. A method for inspecting a length-measurable product, which during a process of manufacturing the length-measurable product whose length at least in one direction can be measured, when a defect occurs in the length-measurable product, applies a marking to a length-measurable product having the defect,
the method comprising the steps of:
detecting presence of a defect in the length-measurable product;
measuring a length of the length-measurable product at least in one direction; and
applying a marking to a predetermined position in a length direction of the length-measurable product having the defect, on the basis of positional information on the defect obtained in the defect detecting step and length measurement information obtained in the length measuring step.

2. The method for inspecting a length-measurable product according to claim 1, further comprising the step of
conveying the length-measurable product, wherein
the length-measurable product is a product that is continuously manufactured without interruption at least during conveyance by the conveying step.

3. The method for inspecting a length-measurable product according to claim 1, further comprising the step of
collecting the length-measurable product, wherein
the collecting step is a step of winding the length-measurable product with a certain cycle, and
a position at which the marking is applied in the marking step to the length-measurable product having the defect is determined on the basis of a rotation cycle or rotation angle of the length-measurable product in consideration of winding thickening thereof in the collecting step.

4. The method for inspecting the length-measurable product according to claim 1, further comprising the step of
collecting the length-measurable product, wherein
the collecting step is a step of collecting the length-measurable product while turning around the length-measurable product at a certain length, and
a position at which the marking is applied in the marking step to the length-measurable product having the defect is determined on the basis of a cycle of turned-around length in the collecting step.

5. The method for inspecting a length-measurable product according to claim 1, further comprising the step of
collecting the length-measurable product, wherein
the collecting step is a step of collecting the length-measurable product while cutting the length-measurable product into a certain length, and
a position at which the marking is applied in the marking step to the length-measurable product having the defect is determined on the basis of a cut length in the collecting step.

6. The method for inspecting a length-measurable product according to claim 1, wherein
two or more lines of the length-measurable products are manufactured in parallel.

7. The method for inspecting a length-measurable product according to claim 6, wherein
in the marking step, the marking is applied with marking heads in a number less than the number of lines of the length-measurable product.

8. A method of manufacturing a length-measurable product comprising the step of
inspecting the length-measurable product in accordance with the method for inspecting a length-measurable product according to claim 1.

9. An inspection device for a length-measurable product, which in a manufacturing device for the length-measurable product whose length at least in one direction can be measured, when a defect occurs in the length-measurable product, applies a marking to a length-measurable product having the defect, the inspection device comprising:
a defect detecting unit that detects presence of a defect in the length-measurable product;
a length measuring unit that measures a length of the length-measurable product at least in one direction, and
a marking unit that applies a marking to a predetermined position in a length direction of the length-measurable product having the defect, on the basis of positional information on the defect obtained from the defect detecting unit and length measurement information obtained from the length measuring unit.

10. The inspection device for a length-measurable product according to claim 9, further comprising
a conveying unit that conveys the length-measurable product, wherein
the length-measurable product is a product that is continuously manufactured without interruption at least during conveyance by the conveying unit.

11. The inspection device for a length-measurable product according to claim 9, further comprising
a collecting unit that collects the length-measurable product, wherein
the collecting unit is a unit that winds the length-measurable product with a certain cycle, and
a position at which the marking unit applies the marking to the length-measurable product having the defect is determined on the basis of a rotation cycle or rotation angle of the length-measurable product in consideration of winding thickening thereof in the collecting unit.

12. The inspection device for a length-measurable product according to claim 9, further comprising
a collecting unit that collects the length-measurable product, wherein
the collecting unit is a unit that collects the length-measurable product while turning around the length-measurable product at a certain length, and
a position at which the marking unit applies the marking to the length-measurable product having the defect is determined on the basis of a cycle of turned-around length in the collecting unit.

13. The inspection device for a length-measurable product according to claim 9, further comprising
a collecting unit that collects the length-measurable product, wherein
the collecting unit is a unit that collects the length-measurable product while cutting the length-measurable product into a certain length, and
a position at which the marking unit applies the marking to the length-measurable product having the defect is determined on the basis of a cut length in the collecting unit.

14. The inspection device for a length-measurable product according to claim 9, wherein
two or more lines of the length-measurable products are manufactured in parallel.

15. The inspection device for a length-measurable product according to claim 14, wherein
in the marking unit, the number of marking heads is less than the number of lines of the length-measurable products.

16. A manufacturing device for a length-measurable product, comprising an inspection device for the length-measurable product according to claim 9.
